(19) United States
(12) Patent Application Publication
(10) Pub. No.: US 2016/0217581 A1
(43) Pub. Date: Jul. 28, 2016

(54) DRIVING CONDITION IDENTIFICATION SYSTEM

(71) Applicant: PAPAGO INC., Taipei City (TW)

(72) Inventors: Shiuan-Yi SU, Taipei City (TW); Liang-Yi CHIEN, Taipei City (TW)

(21) Appl. No.: 14/603,915

(22) Filed: Jan. 23, 2015

(51) Int. Cl. G06T 7/00; G06K 9/00; G06T 7/20; H04N 7/18

(52) U.S. Cl. CPC G06T 7/0044; H04N 7/18; G06K 9/00201; G06K 9/00805; G06K 9/00825; G06T 7/20; G06T 7/0089; G06T 2207/10016; G06T 2207/10028; G06T 2207/30196; G06T 2207/30232; G06T 2207/30236; G06T 2207/30261

(57) ABSTRACT

A driving condition identification system mounted in a car, including an image capture unit adapted for capturing images of the scene in front of the car to produce a continuous video signal when the car stands still, and an operation processing unit electrically coupled with the image capture unit and adapted for receiving and processing the continuous video signal to determine images of an object in the continuous video signal in front of the car, to analyze changes in the images of the object in front of said car, and to determine the object in front of the car to be in movement or not.

### BACKGROUND OF THE INVENTION

1. Field of the Invention

The present invention relates to image identification technology and more particularly, to a driving condition identification system for use in a car to identify the presence of an object and its movement in front of the car.

2. Description of the Related Art

A driving image recording system or driving recording device is adapted for use in a car to directly record images in front of the car when the car is moving, i.e., when the video camera of the driving recording device is initiated, it keeps converting the image signal from the video camera into image data. Using this driving imaging technology with image recognition and analysis can further help the driver obtain the traffic conditions in front of the car.

Further, reversing radar systems widely used in cars commonly use ultrasonic sensors to detect obstacles around the car. When an obstacle enters a predetermined range around the car, the alarm immediately gives off an audio warning signal in different frequencies subject to different distances. According to the frequencies of the audio warning signal, the driver can figure out the distance between the obstacle and the car without directly viewing the scene in the front, rear, left or right side of the car when the driver parks, reverses or starts the car, improving driving safety. Further, an advanced reversing radar system is equipped with a video camera. When the car is shifted into the reverse gear, the in-vehicle display device displays the video images being captured by the video camera, and thus, the driver can see the presence of any obstacles around the car from the images being displayed in the in-vehicle display device and figure out the distance between the obstacles and the car according to the audio warning signal produced by the reversing radar system.

However, the conventional reversing radar systems or driving recording systems and devices are adapted to help the driver obtain the driving conditions behind the car or to record images in front of the car when the car is moving. If the driver receives a phone call or searches the cell phone or other objects in the car as the car stands still or stops during the red light, the driver may be unable to see the traffic conditions in front of the car or to know any front traffic condition changes. Further, there is no any driving condition identification designs commercially available for assisting the driver to obtain the driving conditions in front of the car.

### SUMMARY OF THE INVENTION

The present invention has been accomplished under the circumstances in view. It is the main object of the present invention to provide a driving condition identification system, which captures images of the scene in front of the car to produce a video signal and then analyzes the video signal to determine the presence and movement of an object in front of the car, and provides a warning signal to remind the driver when the object in front of the car moves, enabling the driver to effectively obtain the traffic condition in front of the car and assuring a high level of driving safety.

To achieve this and other objects of the present invention, a driving condition identification system of the invention is mounted in a car, comprising an image capture unit adapted for capturing images of the scene in front of the car to produce a continuous video signal when the car stands still, and an operation processing unit electrically coupled with the image capture unit and adapted for receiving and processing the continuous video signal to determine images of an object in the continuous video signal in front of the car, to analyze changes in the images of the object in front of the car, and to determine the object in front of the car to be in movement or not.

Preferably, the operation processing unit analyzes the continuous video signal to determine the presence of the image of the object in the continuous video signal according to an information of object characteristics.

Preferably, the operation processing unit analyzes changes in the images of the object in front of the car by defining the contour of the object in the images in front of the car within the cover range of the continuous video signal and determining movement of the object subject to changes of the contour and size of the object.

Preferably, the operation processing unit analyzes changes in the images of the object in front of the car by defining a light source emitted by the object in front of the car within the cover range of the continuous video signal and determining a change of the object subject to changes of the light source.

Preferably, the information of object characteristics contains the information of the characteristic of pedestrians, the information of the characteristics of animals, the information of the characteristics of car boots, and/or the information of the characteristics of traffic light sets.

In another embodiment of the present invention, the driving condition identification system further comprises a sonic transmitter unit and a sonic sensor unit respectively electrically coupled to the operation processing unit. The sonic transmitter unit is adapted to transmit a sonic signal in direction toward the front side of the car. The sonic sensor unit is adapted to detect a reflected wave signal corresponding to the sonic signal. Further, the operation processing unit converts the reflected wave signal into a distance value, and determines that the object in front of the car is moving or immovable subject to changes in the images of the object in front of the car and changes of the distance value when the car stands still.

In another embodiment of the present invention, the driving condition identification system further comprises a light transmitter unit and a light sensor unit respectively electrically coupled to the operation processing unit. The sonic light transmitter unit is adapted to transmit a light signal in direction toward the front side of the car. The light sensor unit is adapted to detect a reflected light signal corresponding to the light signal. Further, the operation processing unit converts the reflected light signal into a distance value, and determines that the object in front of the car is moving or immovable subject to changes in the images of the object in front of the car and changes of the distance value when the car stands still.

Thus, the driving condition identification system of the invention uses an image capture unit to capture the images of the scene in front of the car and an operation processing unit to analyzes the video signal provided by the image capture unit so as to determine the presence and movement of an object in front of the car when the car stands still. When the traffic condition in front of the car changes as the car stands still, the operation processing unit provides a warning signal to remind the driver, enabling the driver to effectively obtain the traffic condition in front of the car and assuring a high level of driving safety.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a driving condition identification system in accordance with the present invention.

FIGS. 2A through 2D illustrate a first architecture of the driving condition identification system in accordance with the present invention.

FIGS. 3A through 3C illustrate a second architecture of the driving condition identification system in accordance with the present invention.

FIGS. 4A through 4C illustrate a third architecture of the driving condition identification system in accordance with the present invention.

### DETAILED DESCRIPTION OF THE INVENTION

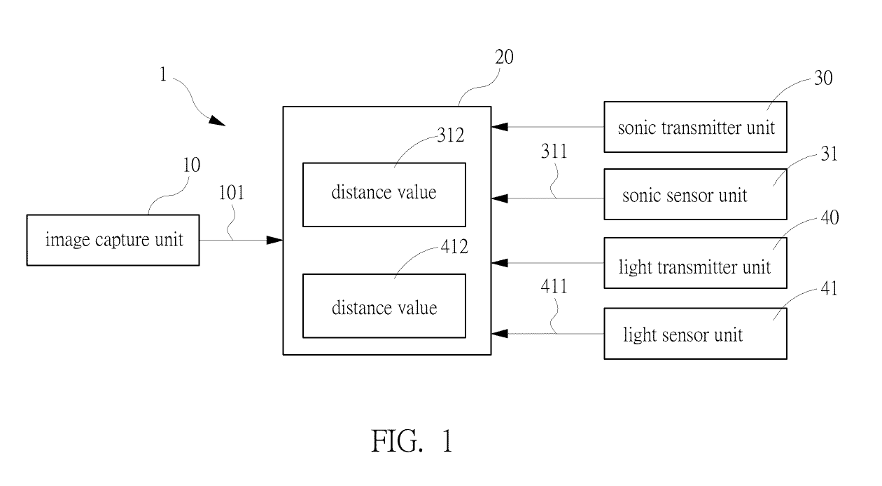

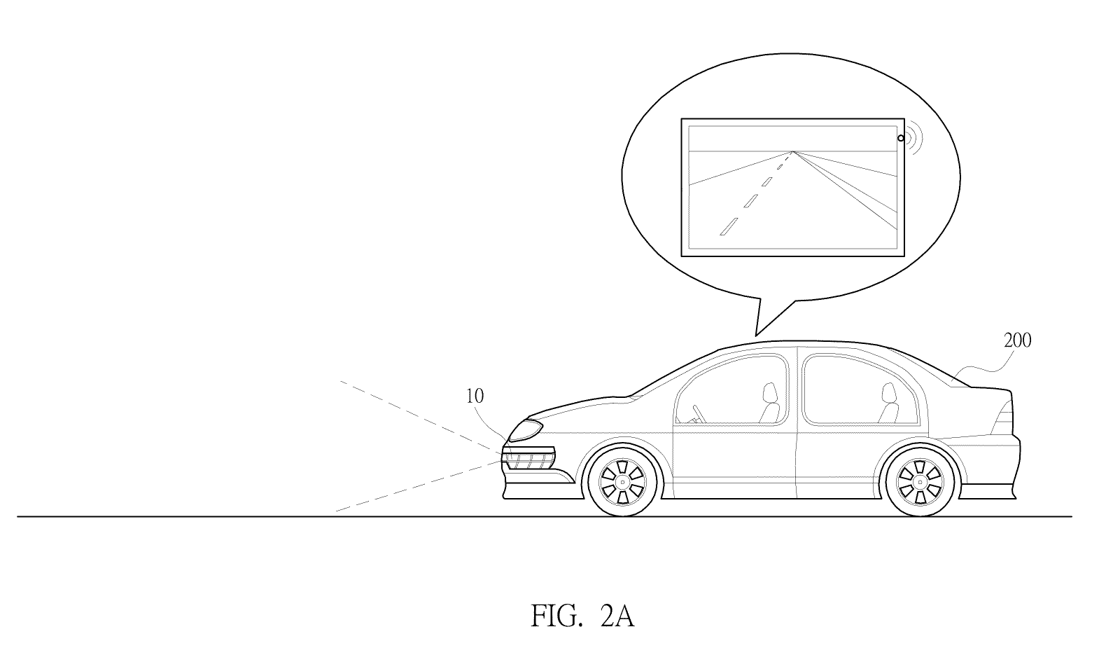

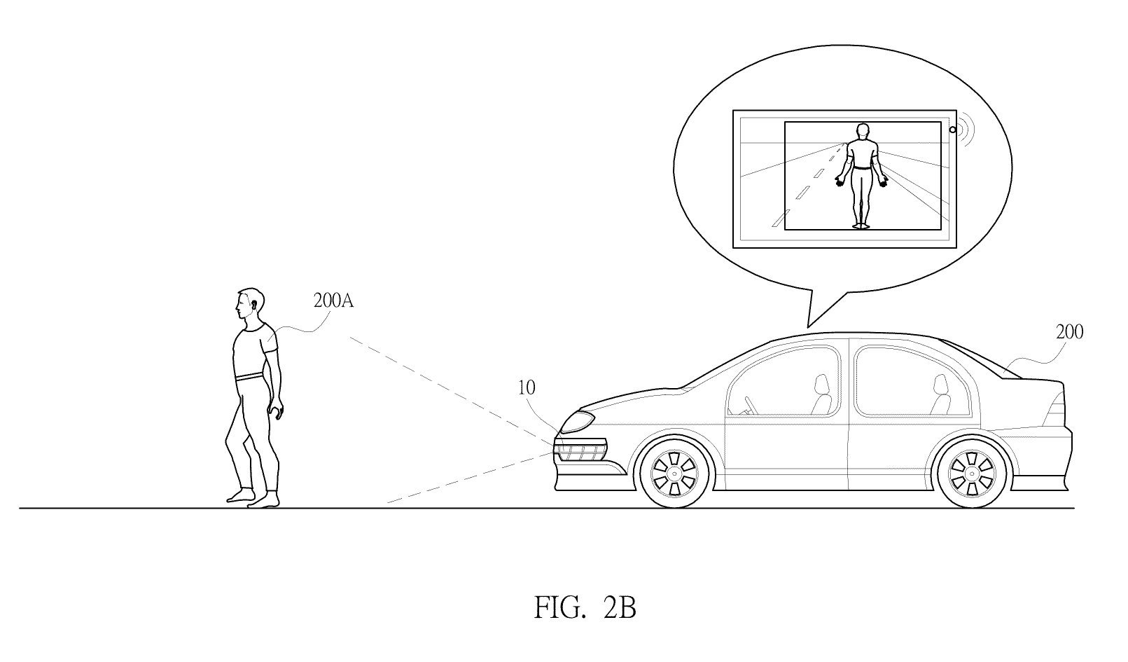

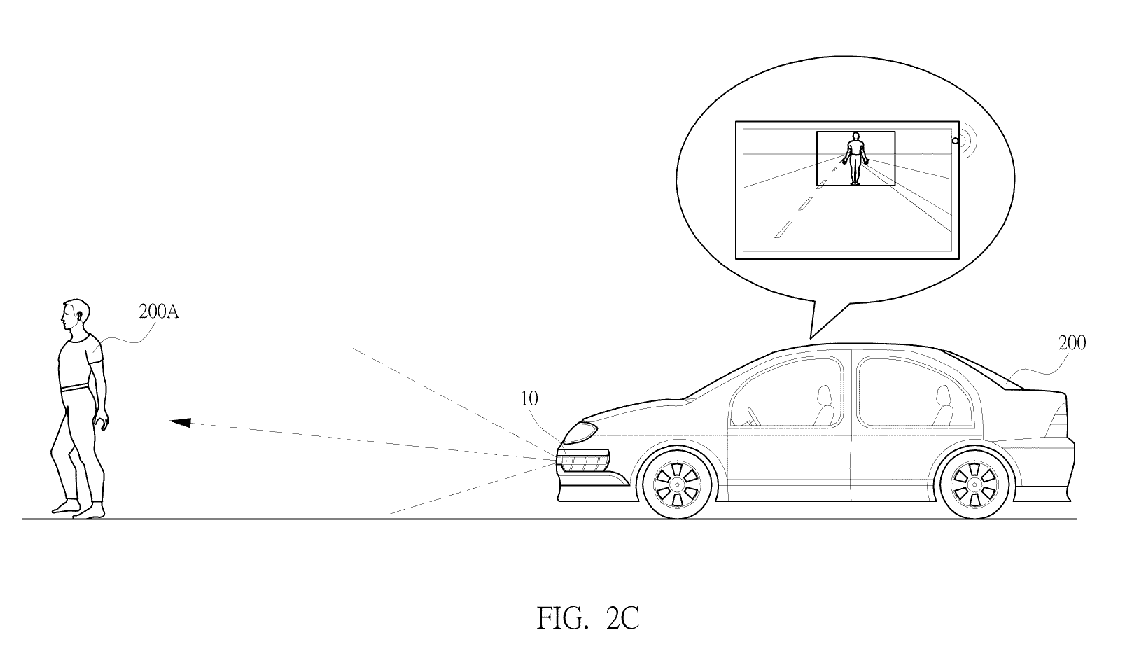

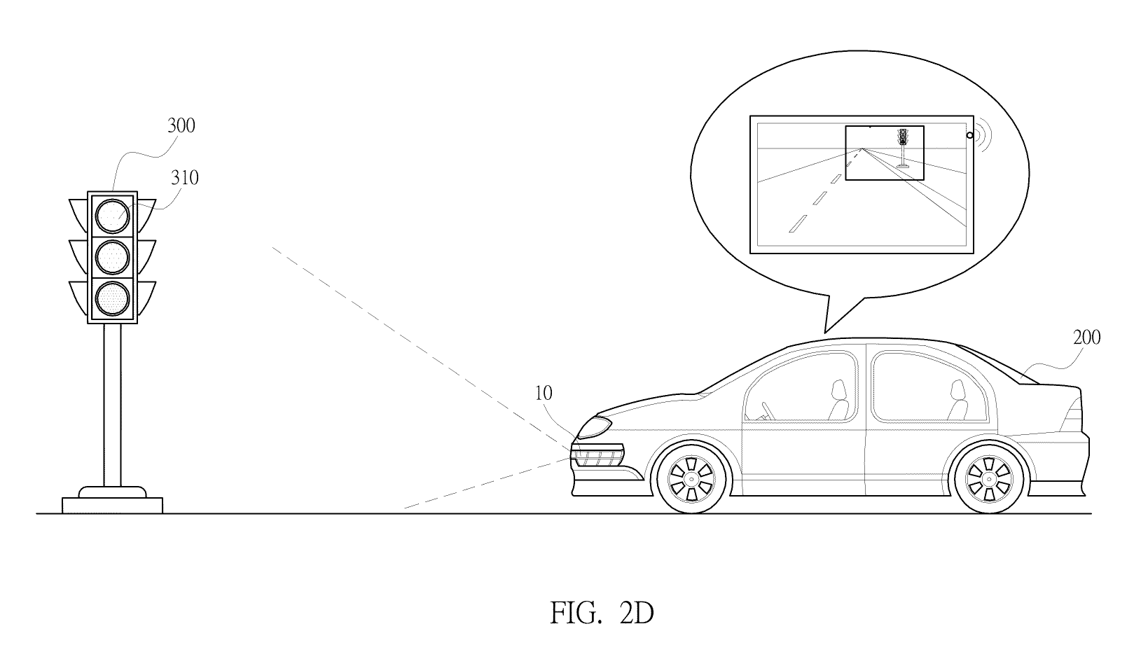

Referring to FIGS. 1 and 2A through 2D, a driving condition identification system based on a first architecture in accordance with the present invention is shown. The driving condition identification system 1 is installed in a car 200, comprising an image capture unit 10 adapted for capturing images of the scene in front of the car 200 to produce a continuous video signal 101 when the car 200 stands still, and an operation processing unit 20 electrically coupled with the image capture unit 10 adapted for receiving and processing the continuous video signal 101 to determine the images of an object in the continuous video signal 101 in front of the car, to analyze changes in the images of the object in front of the car, and to determine movement of the object in front of the car.

The image capture unit 10 captures images in direction toward the front side of the car 200 to produce a continuous video signal 101. The image capture unit 10 can be camera module, camera circuit, imaging apparatus, or any of a variety of image pickup devices, such as CCD camera lens, video camera, etc. The continuous video signal 101 can be a streaming video, or a dynamic picture data of continuous camera pictures.

As stated above, in one embodiment of the present invention, after the operation processing unit 20 received the continuous video signal 101, it analyzes the continuous video signal 101 according to an information of object characteristics, determining whether or not there is any object image in the continuous video signal 101 in front of the car.

In FIG. 2A, there is no any object in front of the car 200 as the car 200 stands still, the image capture unit 10 captures the images in front of the car 200 to produce a continuous video signal 101 and to transmit this continuous video signal 101 to the operation processing unit 20 for analysis. At this time, the operation processing unit 20 identifies that there is no any object in front of the car 200, and therefore it gives no alarm. In FIG. 2B, an object 200A appears in front of the car 200 as the car 200 stands still, the image capture unit 10 captures the images in front of the car 200 to produce a continuous video signal 101 and to transmit this continuous video signal 101 to the operation processing unit 20 for analysis. At this time, the operation processing unit 20 verifies the existence of an object 200A in front of the immovable car 200.

As stated above, in one example of the present invention, when the operation processing unit 20 analyzes changes in the images of a pedestrian in front of the car, it defines the contour of the pedestrian in front of the car within the cover range of the continuous video signal 101 and determines movement of the pedestrian subject to changes of the contour and size of the object.

As illustrated in FIG. 2C, when the car 200 stands still and the position of the pedestrian 200A in front of the car 200 is changed, the image capture unit 10 captures image changes of the pedestrian in front of the car and transmits the images of the pedestrian to the operation processing unit 20 for analysis. After the operation processing unit 20 analyzes the changes in the images of the pedestrian in front of the car, it provides a warning signal to remind the driver of the movement of the pedestrian in front of the car.

As stated above, in another example of the present invention, when the operation processing unit 20 analyzes changes in the images of a light source 310 emitted by an object 300 in front of the car, it defines the contour of the light source 310 of the object 300 in front of the car within the cover range of the continuous video signal 101 as the car stands still and determines changes of the contour and size of the light source 310 emitted by the object 300 in front of the car, and then provides a warning signal to remind the driver.

As illustrated in FIG. 2D, when the car 200 stands still and the light source of a traffic light set 300 in front of the car 200 is changed, the image capture unit 10 captures image changes of the light source of the traffic light set 300 in front of the car and transmits the images of the light source of the traffic light set 300 to the operation processing unit 20 for analysis. After the operation processing unit 20 analyzes the changes in the images of the light source of the traffic light set in front of the car, it provides a warning signal to remind the driver of the change of the traffic signal of the traffic light set 300.

As stated above, the information of object characteristics includes the information of pedestrian characteristics, the information of animal characteristics and/or the information of the characteristics of car boots, or the information of the characteristics of traffic light set. i.e., when the car 200 stands still, the operation processing unit 20 analyzes the continuous video signal 101 provided by the image capture unit 10 using the characteristics of pedestrians, animals, car boots and traffic light sets to determine the presence of any pedestrian, animal, car boot and/or traffic light set in front of the car and any change of their images.

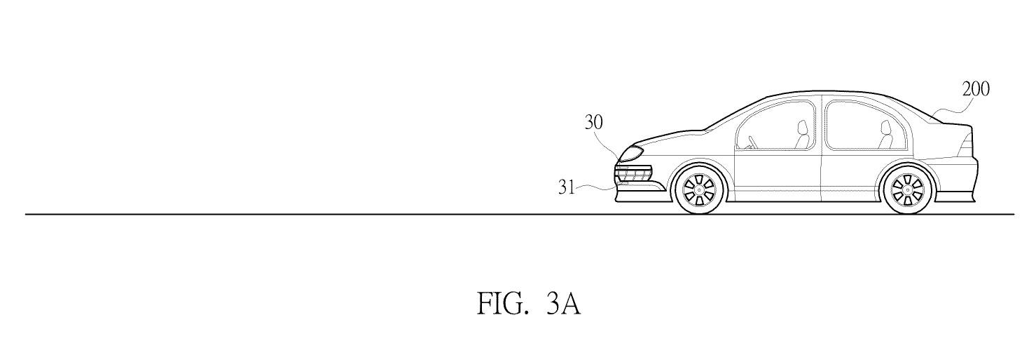

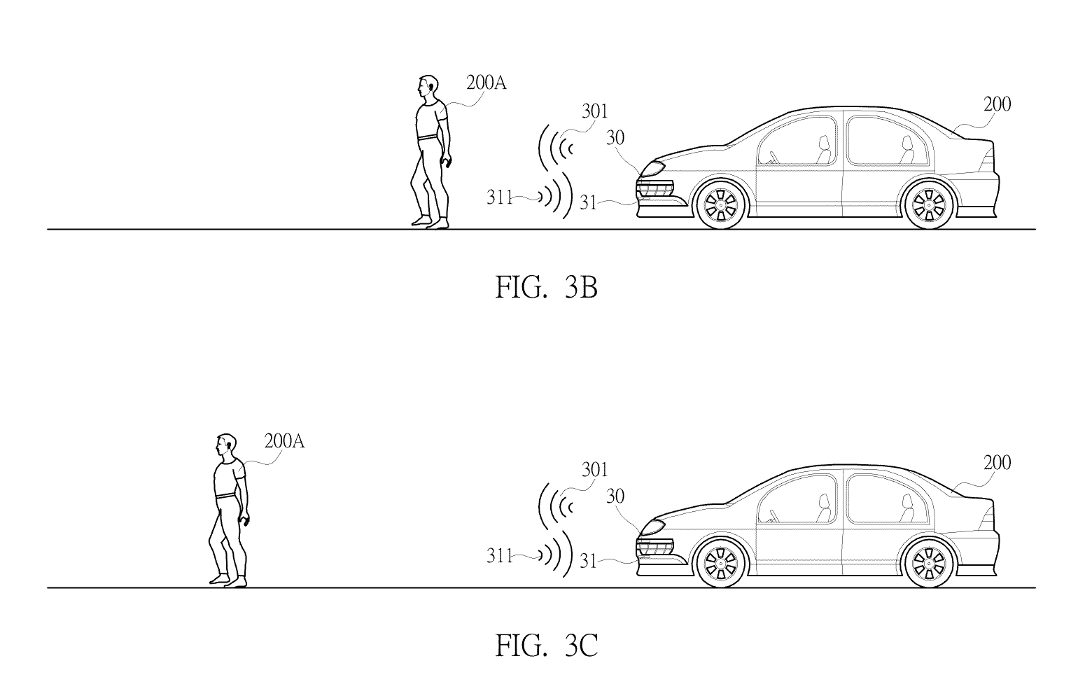

Referring to FIGS. 3A through 3D and FIG. 1 again, a driving condition identification system based on a second architecture in accordance with the present invention is shown. According to this second embodiment, the driving condition identification system further comprises a sonic transmitter unit 30 and a sonic sensor unit 31 respectively electrically coupled to the operation processing unit 20. The sonic transmitter unit 30 is adapted to transmit a sonic signal 301 in direction toward the front side of the car 200. The sonic sensor unit 31 is adapted to detect a reflected wave signal 311 corresponding to the sonic signal 301. The operation processing unit 20 converts the reflected wave signal 311 into a distance value 312, and determines that the object 200A in front of the car 200 is moving or immovable subject to changes in the images of the object 200A in front of the car 200 and changes of the distance value when the car 200 stands still.

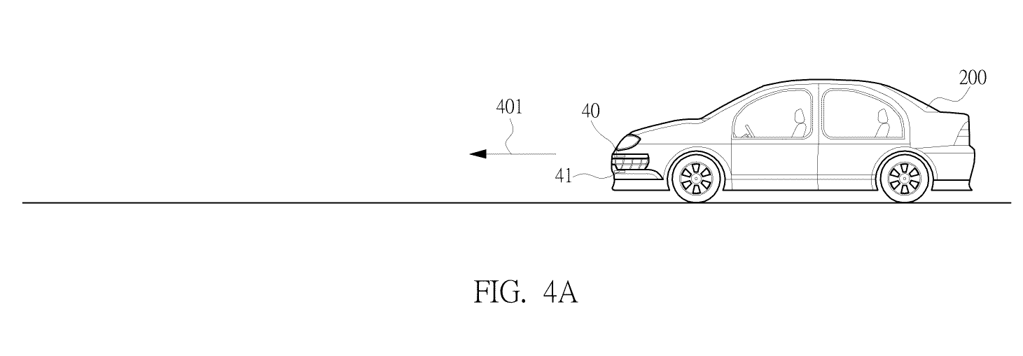

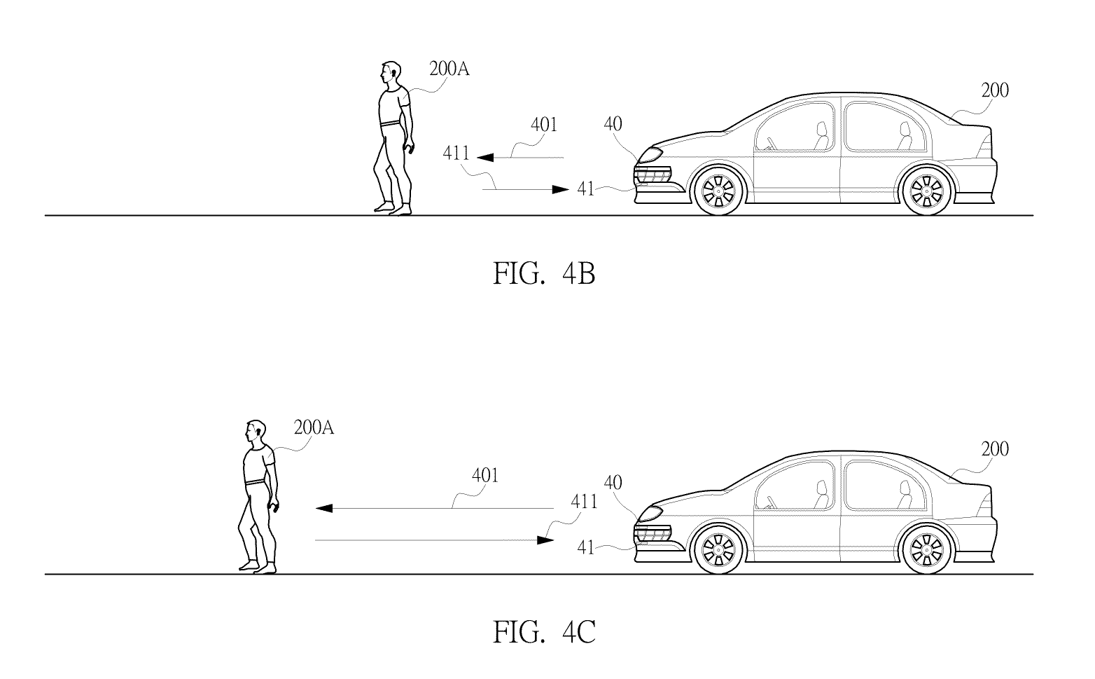

Referring to FIGS. 4A through 4D and FIG. 1 again, a driving condition identification system based on a third architecture in accordance with the present invention is shown. According to this third embodiment, the driving condition identification system further comprises a light transmitter unit 40 and a light sensor unit 41 respectively electrically coupled to the operation processing unit 20. The sonic light transmitter unit 40 is adapted to transmit a light signal 401 in direction toward the front side of the car 200. The light sensor unit 41 is adapted to detect a reflected light signal 411 corresponding to the light signal 401. The operation processing unit 20 converts the reflected light signal 411 into a distance value 412, and determines that the object 200A in front of the car 200 is moving or immovable subject to changes in the images of the object 200A in front of the car 200 and changes of the distance value when the car 200 stands still.

Although particular embodiments of the present invention have been described in detail for purposes of illustration, various modifications and enhancements may be made without departing from the spirit and scope of the invention. Accordingly, the invention is not to be limited except as by the appended claims.

What is claimed is:

1. A driving condition identification system mounted in a car, comprising:
an image capture unit adapted for capturing images of the scene in front of said car to produce a continuous video signal when said car stands still; and
an operation processing unit electrically coupled with said image capture unit and adapted for receiving and processing said continuous video signal to determine images of an object in said continuous video signal in front of said car, to analyze changes in the images of said object in front of said car, and to determine said object in front of said car to be in movement or not.

2. The driving condition identification system as claimed in claim 1, wherein said operation processing unit analyzes said continuous video signal to determine the presence of the image of said object in said continuous video signal according to an information of object characteristics.

3. The driving condition identification system as claimed in claim 1, wherein said operation processing unit analyzes changes in the images of said object in front of said car by defining the contour of said object in the images in front of said car within the cover range of said continuous video signal and determining movement of said object subject to changes of the contour and size of said object.

4. The driving condition identification system as claimed in claim 1, wherein said operation processing unit analyzes changes in the images of said object in front of said car by defining a light source emitted by said object in front of said car within the cover range of said continuous video signal and determining a change of said object subject to changes of said light source.

5. The driving condition identification system as claimed in claim 2, wherein said information of object characteristics contains the information of the characteristic of pedestrians, the information of the characteristics of animals, the information of the characteristics of car boots, and/or the information of the characteristics of traffic light sets.

6. The driving condition identification system as claimed in claim 1, further comprising a sonic transmitter unit and a sonic sensor unit respectively electrically coupled to said operation processing unit, said sonic transmitter unit being adapted to transmit a sonic signal in direction toward a front side of said car, said sonic sensor unit being adapted to detect a reflected wave signal corresponding to said sonic signal, wherein said operation processing unit converts said reflected wave signal into a distance value, and determines that said object in front of said car is moving or immovable subject to changes in the images of said object in front of said car and changes of said distance value when said car stands still.

7. The driving condition identification system as claimed in claim 1, further comprising a light transmitter unit and a light sensor unit respectively electrically coupled to said operation processing unit, said sonic light transmitter unit being adapted to transmit a light signal in direction toward a front side of said car, said light sensor unit being adapted to detect a reflected light signal corresponding to said light signal, wherein said operation processing unit converts said reflected light signal into a distance value, and determines that said object in front of said car is moving or immovable subject to changes in the images of said object in front of said car and changes of the distance value when said car stands still.

8. The driving condition identification system as claimed in claim 1, wherein said operation processing unit analyzes changes in the images of said object in front of said car by defining the contour of said object in the images in front of said car within the cover range of said continuous video signal and determining movement of said object subject to changes of the contour and size of said object.
